(19) United States
(12) Patent Application Publication
(10) Pub. No.: US 2016/0265514 A1
(43) Pub. Date: Sep. 15, 2016

(54) SUPPORT DEVICE AND METHODS FOR IMPROVING AND CONSTRUCTING A SUPPORT DEVICE

(71) Applicant: TOWER DYNAMICS LLC, Conyers, GA (US)

(72) Inventor: Timothy Wade Cook, Conyers, GA (US)

(73) Assignee: TOWER DYNAMICS LLC, Conyers, GA (US)

(21) Appl. No.: 15/028,707

(22) PCT Filed: Mar. 24, 2014
(86) PCT No.: PCT/EP2014/055864

§ 371 Date: Apr. 11, 2016

(30) Foreign Application Priority Data
Oct. 11, 2013 (NL) 2011590

(51) Int. Cl. F03D 13/20; E02D 27/42; F03D 7/02; E04H 12/34

(52) U.S. Cl. CPC F03D 13/20; E04H 12/34; E02D 27/425; F03D 7/0296; F05B 2230/60

(57) ABSTRACT

The present invention relates to a support device, more particularly a structural part of a tower construction for mounting a wind turbine, comprising:
at least one elongated structural member (102) comprising one or more voids (104) extending over a substantial height of said elongate structural member (102); and
a granular core filling material (103) filling at least one of the one or more voids (104) over a substantial height of said elongated structural member (102), wherein the granular filling material (103) is in engagement with the structural member (102) such that it exerts a pressure and provides stiffness against deformation on the surrounding structural member (102).

The invention further relates to a tower construction, comprising at least one such support device, as well as methods for improving and constructing such a support device.

### CROSS-REFERENCE TO RELATED APPLICATIONS

This application claims priority from co-pending PCT Patent Application Ser. No. PCT/EP2014/055864 filed on Mar. 24, 2014, which is titled “SUPPORT DEVICE AND METHODS FOR IMPROVING AND CONSTRUCTING A SUPPORT DEVICE”, and Netherlands Patent Application 2011590 filed on Oct. 11, 2013, both of which are hereby incorporated in their entirety by reference.

### FIELD OF THE INVENTION

The present invention relates to a support device, more particularly a structural part of a tower construction for mounting a wind turbine.

The invention further relates to a tower construction, comprising at least one such support device, as well as methods for improving and constructing such a support device.

### BACKGROUND OF THE INVENTION

At least some known wind turbines include a tower and a nacelle mounted on the tower. A rotor is rotatably mounted to the nacelle and is coupled to a generator by a shaft. A plurality of blades extends from the rotor. The blades are oriented such that wind passing over the blade turns the rotor and rotates the shafts, thereby driving the generator to generate electricity.

In relation to the state of the art, it should be mentioned that the wind power field, which is widely expanding both onshore and offshore, is in search of greater cost effectiveness, which has resulted in the design and commercialization of increasingly more powerful wind turbines, with 3, 5 or even up to 15 MW designs, and interest in higher hub heights in certain locations to access more cost effective wind resource.

Typical wind turbine towers of today are built by means of curved and electrowelded metal plates, transversely attached by means of flanges. This type of tower construction will be referred to as traditional towers.

These tubular shaped traditional towers with small structural footprints are popular in the wind industry for reasons related to land leasing, rapid and easy construction, and aesthetics. It is noted that construction time is considered among the major cost drivers in a wind farm project.

As wind turbine structures get taller and larger, the tower gains an increasing share of the total cost of energy, and the feasibility (economic and technical) of traditional welded steel shell towers is limited by onshore transportation constraints.

Transporting large diameter tower sections that are desirable for use in very tall towers is challenging. As wind turbine towers have become taller, the cross-sectional dimensions of the tower section, particularly near the base section, are constrained by transportation challenges. As an example, in the U.S. the maximum transported cross sectional dimension is 4.3 in and in some routes 4.6 in, to fit under overhead obstructions. Although alternative side roads can sometimes be used to avoid highway obstructions, the road weight limits on these side roads can limit them from being an option with large heavy tower sections. Still, it is possible to build a 160 in tall tower limited to only 4.3 m in diameter, but very large thicknesses will be required resulting sharp increases in steel tonnage and shorter tower sections must be used to satisfy weight limitations. Large steel wall thicknesses lead to increased welding demands and when the thickness is greater than 40 mm, a yield strength reduction is required by steel codes. As a result, building taller (90 m+) traditional cylindrical steel shell towers constrained to only 4.3 m in diameter results in a sharp increase in steel tonnage and capital costs that is currently limiting industry access to higher hub heights and economic development of low- to mid-class wind resources that are abundant, for example, in the Southeast, Northeast, and Western United States.

The new tower demands constrained by onshore logistics capabilities oblige rethinking the support structures or towers bearing the wind turbine which are increasingly slender and must withstand much larger forces at much higher hub heights, for example beyond 120 in onshore and larger than 1.5 MW.

Some alternatives to the traditional tower design have been proposed in response to the wind industry trends. Published candidates involve friction bolted steel shells, concrete, hybrid concrete-steel towers, wood-based towers, lattice towers, guyed towers, and sandwich constructions. However, most proposed new designs are focused on material selection and are either radical requiring significant time for wide-spread implementation in the industry or have an innate disadvantage, i.e. visual, construction time, availability, or reliability, when compared with the traditional tower. Among the concepts, the hybrid concrete-steel towers and friction bolted steel shells have been the most popular so far. Traditional sandwich towers for wind energy converters have been shown to significantly increase ultimate strength in local buckling by more than 40% and to reduce the required steel tonnage by 13%. However, these require injection and curing time of the core material (grout, elastomer, concrete), and such embodiment requires two large diameter steel shells of high yield strength which imply fabrication challenges.

Small footprints and higher hub heights inevitably lead to increasingly slender tower constructions. As the tower becomes more slender the structural dynamics become increasingly significant and material utilization tends to decrease, especially in steel shell tower constructions, which may be traditional welded or friction bolted constructions.

With most tower designs it is difficult to tune the dynamic characteristics of the tower construction without increasing complexity or adding structural mass and cost, especially for steel shell towers. The dynamic characteristics are important, especially in relation to fatigue damage, resonant interaction between the tower and rotor, noise generation, and turbine motions. Further, it is known that a significant amount of noise generated by a wind turbine system is associated with the structural vibrations of the tower. Therefore a tower design which facilitates easy dynamic tuning and damping is advantageous.

In traditional steel shell towers, material utilization is limited by instabilities related to buckling. These instabilities become even more pronounced as the slenderness increases with either decreasing shell thickness or increasing tower height. Less material utilization leads to less cost effective structural solutions. Therefore a design characterized by a cost-effective means of increasing shell buckling stability, will lead to significant cost savings in the structure.

It also should be noted that the buckling failure mode of a traditional shell tower tends to be catastrophic, sometimes resulting in the wind turbine crashing to the ground. A falling wind turbine system introduces many hazards, for example, to the safety of maintenance personnel or complete loss of investment. It is therefore interesting for a tower construction design to be robust against the buckling failure mode in the event of over loading or blade impact and to remain in a substantially upright position.

An additional industry problem that has motivated the development of the present invention involves repowering existing installations. A lot of value of an existing installation lies in the rights to harvest wind at the particular location, but recycling the old wind turbine tower constructions is a problem. The easiest way to recycle the old tower would be continued use, but it would need to be adapted and certified to support a new, and probably much larger wind turbine.

The above mentioned insights and challenges facing the wind energy industry with regard to the design and construction of taller and larger towers are summarized as:
favorable aesthetics, rapid and easy construction, and small footprints are preferred;
logistics challenges are critical design considerations and wall thickness is important;
the dynamic performance is of increasing significance;
it is difficult to tune the dynamic behavior of the tower without increasing complexity or adding additional cost;
material utilization in steel shell towers is significantly limited by buckling instabilities;
a solution which can be built today with little change in supply chain is preferable;
traditional tower buckling failure tends to be sudden and catastrophic; and
recycling of existing tower installations is challenging.

Such objectives as indicated above, and/or other benefits or inventive effects, are attained according to the present disclosure by the assembly of features in the appended independent device claims and in the appended independent method claims.

### SUMMARY OF THE INVENTION

Said object is achieved with the support device, more particularly a structural part of a tower construction for mounting a wind turbine, according to the present invention, said support device comprising:
at least one elongated structural member comprising one or more voids extending over a substantial height of said elongate structural member; and
a granular core filling material filling at least one of the one or more voids over a substantial height of said elongated structural member, wherein the granular filling material is in engagement with the structural member such that it exerts a pressure and provides stiffness against deformation on the surrounding structural member.

The granular filling material engages with the surface of the structural member(s) such that it exerts a pressure against the wall(s) of said structural member(s) and provides stiffness against displacement. In this way, the granular fill acts to enhance the buckling strength of at least one structural member, and also provides passive damping to the support device. It furthermore provides a means of tuning dynamics characteristics of the construction, i.e. the support device and any section supported by said support device.

Internal pressure and internal stiffness exerted on the structural member by engagement with the granular core improves the buckling stability of the structural member. This leads to advantageous strength gains and a more favorable ductile failure behavior which can substantially reduce risks that are otherwise associated with buckling instabilities of traditional tubular tower sections. Further, the added buckling capacity provides advantages for fabrication and transportation of large tower base sections by allowing shell thickness reductions, especially in combination with higher yield strength steels, without substantial strength reductions that would be required for unstiffened sections.

The principle behind particle damping is the removal of vibratory energy through losses that occur during impact or friction of granular particles which move freely with the boundaries of the void attached to a primary system. Notable advantages of particle damping when compared to other methods of damping include: performance through a large range of temperatures, they can survive a long life, they are effective over a wide range of frequencies, the particles placed inside a cavity can be less weight than the mass they replace, they are passive and hence have no dependency on electric power, and the material selection facilitates tuning for a given application. Further, neighboring industries have proven that a significant degree of noise reduction can be achieved by filling structural members with granular materials.

It is noted that the granular core filling material fills at least one of the one or more voids over a substantial height of said elongated structural member, wherein ‘over a substantial height’ of said elongate structural member is to be understood as at least two times the characteristic width, or diameter, of said elongated structural member.

According to an exemplary embodiment, the hollow elongate member comprises a substantially axis-symmetric structural member. An axis-symmetric structural member such as a substantially circular tube is advantageous because the structural member is subject to bending in arbitrary directions. Also, the axis-symmetric shape is preferable when using a granular core because it carries the stresses due to the internal pressure/resistance evenly. Finally, an axisymmetric shape leads to easier analysis and design.

According to another embodiment, the granular filling material comprises a substantially rigid solid-state material. This substantially rigid solid-state material has the advantage that it can be a readily available material, such as sand or recycled granular waste.

Due to its grain size, a solid state material—in contrast to a fluid—may be arranged inside the voids without the need for any specific sealing, such as a watertight sealing.

According to another embodiment, the cross sectional area of at least one of the voids decreases from a first end of said void towards an opposite, second end of said void, wherein—when said elongated structural member is in a substantially upright orientation during use—said first end forms the lower end of said void and said second end forms the upper end of said void. When self weight of the granular fill material is the primary source of confining pressure for the fill material filling a tall void, the pressure, and thus the stiffness, of the granular material is limited based on the dimensions of the void, the friction coefficient between the granular fill and the wall, and properties of the granular material. When the void has a constant cross sectional area over height, for example a constant diameter, the pressure will reach a limit due to the friction forces between the granular material and the structural member. There are two key advantages in the present invention wherein the structural member is oriented in a substantially vertical direction and the void has a non-constant cross sectional area, i.e. tapered diameter, which is largest at the base. The increase in cross sectional area of the void with depth leads to higher confining pressure in the granular fill due to self weight, and reduced compressive stresses in the structural member. This results from reduced vertical friction forces between the granular fill and the surrounding walls of the structural member.

According to another embodiment, the granular filling material is arranged in said void under pre-pressure. The pre-pressure of the granular fill pre-stresses the structural member that comprises the voids, and in this way increases the buckling strength. It furthermore provides the opportunity to tune the dynamic damping of said structural member.

According to another embodiment, the granular filling material is bound on at least one end by a cover that completely fits in the one or more voids and wherein said cover is in engagement with the granular filling material. The stiffness, and therefore utility of the granular fill core is highly dependent on the confining pressure. Useful confining pressure can be achieved in two ways: first, by the self weight of the stored granular fill and having a diameter greater than −3 meters and a substantial height, or second by having a cover, hereinafter also referred to as ‘cap’, which engages with the granular fill and which exerts a confining pressure over the design life. When self weight of the granular fill is used, however, the stiffness near the free surface of the granular fill is small and the differential stiffness over height presents a design challenge.

According to another embodiment, the cover rests on the granular filling material and is free to move in the longitudinal direction of the elongated structural member such that the self-weight of the cover and the weight of any equipment potentially mounted on the cover acts to exert a confining pressure on the granular filling material. The weight of the cover provides a confining pressure that will remain substantially constant over the design life. Because the cover is free to move, the full weight of said cover is applied on the granular fill and hence used for confining said granular fill.

According to another embodiment, said support device further comprises pre-stressing means that are configured for pressing the cover towards the granular filling material. Additional pre-stressing means provide a ‘confining stress’ to the granular core and also provides a ‘tensioning’ stress to the support device.

According to another embodiment, the pre-stressing means comprise a plurality of buckled bars which exert substantially equal and opposite forces on the cover and the surrounding structural member. Buckled bars are known to exhibit a nearly constant force for large displacements and they are easy to install and maintain.

According to another embodiment, the at least one structural member comprises a flange extending radially in to the void, and wherein the cover is arranged on the flange.

According to another embodiment, the granular filling material is bound on one end by a layer of different granular filling material with at least 10% larger average grain size as the primary granular fill. The filling material with the larger average grain size acts as a simple filter of moisture

According to another embodiment, at least one structural member has a diameter to thickness ratio D/t greater than 30.

The effect of a granular core on increasing the strength in elastic local buckling of a cylindrical shell is a function of the Diameter versus thickness ratio or ‘D/t’ ratio—coupled with the yield strength of the material. In general, the granular fill will be more effective for resisting elastic buckling for higher D/t ratios. However, there are still strength gain benefits in the plastic state for lower D/t ratios, i.e. with a diameter to thickness ratio of at least 30.

Reduction of shell thickness addresses critical fabrication and transportation challenges for large tower structures such as those challenging the deployment of taller and larger wind energy converters onshore.

If the support device comprises a plurality of structural members in a concentric arrangement, at least the outermost structural member has the above mentioned diameter to thickness ratio.

According to another embodiment, at least one structural member is made of steel with yield stress grade of 460 MPa or higher. The invention has particular relevance to wind turbine tower applications—or in general where very large thicknesses are encountered. It becomes advantageous to use higher yield strength steel in combination with the granular core—and the utility of the granular fill increases with Yield strength and D/t ratio. The use of high strength steel to reduce wall thickness is not effective when the structural member is unstiffened due to strength reductions related to local buckling. However, when high strength steels are used in combination with a granular core, a significant increase in buckling capacity is achieved allowing for reduced structural member thicknesses. The combination of a high strength outer structural member and a granular core is particularly advantageous when the diameter is constrained, which is useful in wind turbine tower construction.

According to another embodiment, the granular fill is sand. When compared to traditional sandwich sections such as steel-grout-steel or steel-elastomer-steel, using readily available material such as sand provides advantages by having easy on site fill-up, requiring no cure time and allowing a very large core thickness without negative cost implications.

According to another embodiment, the voids have an annular shape, which reduces the amount of granular fill required for filling the annular void over a substantial height thereof.

According to another embodiment, said support device comprises at least an inner and an outer structural member, which together form a sandwich type section.

According to another embodiment, said support device comprises a portal between the inner and outer structural member allowing personnel access to an inner core of the support device.

According to another embodiment, wherein the support device is part of a tower construction, more particularly a tower construction for mounting a wind turbine.

The invention further comprises a tower construction, comprising at least one support device as described above.

The invention further comprises a wind turbine assembly comprising a wind turbine and a hybrid tower, wherein said hybrid tower 100 comprises an upper tower section and a lower tower section, wherein said upper section comprises an elongate structural member, and herein the lower section comprises a support device as described above.

According to an exemplary embodiment of the wind turbine assembly, the lower section accounts for ¼ to ¾ of the total height of the tower, and wherein the upper section accounts for the remaining ¼ to ¾ of the total height.

The invention further comprises a method for improving a support device comprising at least one elongated structural member comprising one or more voids extending over a substantial height of said elongate structural member, comprising the step of:
filling at least one of the one or more voids over a substantial height of said elongated structural member with a granular core filling material, wherein the granular filling material is in engagement with the structural member such that it exerts a pressure and provides stiffness against deformation on the surrounding structural member.

According to an exemplary embodiment of the method, a support device as described above is used.

The invention further comprises a method for constructing a support device as described above, wherein a lifting system similar to jump-fill concrete systems equipped with a lifting crane is employed to construct, climb and fill the structural members by the following method steps:
positioning the lifting system on or around a foundation;
erecting an elongated inner structural member by the lifting system at the center of the lifting system;
establishing a connection of the lifting system with the inner structural member;
raising the lifting system along said inner structural member to an elevated position;
arranging a segment of an outer structural member below the lifting system, wherein the outer structural member is assembled from two or more circumferential segments; and
filling an annular void separating the inner and outer structural members with granular core filling material filling the annular void over a substantial height of said elongated structural members, wherein the granular filling material is in engagement with the structural members such that it exerts a pressure and provides stiffness against deformation on the surrounding structural members.

According to an exemplary embodiment of the method, the steps are repeated to build a tower construction taller using multiple structural members.

According to a further embodiment of the method, a support device as described above is assembled.

### BRIEF DESCRIPTION OF THE FIGURES

In the following description embodiments of the present invention are further elucidated with reference to the drawing, in which:

FIG. 1 schematically shows a representative wind turbine assembly with tower from a side view;

FIG. 2 illustrates a wind turbine assembly with an inventive tower construction from a longitudinal section view;

FIG. 3 schematically shows a longitudinal section view of an inventive tower construction with features provided by one embodiment of the present invention;

FIG. 4 schematically shows a cross section view of granular filled sandwich type section and a longitudinal section view of an inventive wind turbine tower with features provided by some embodiments of the present invention;

FIG. 5A schematically illustrates a side view of a representative wind turbine assembly comprised of a wind turbine coupled to a tower construction according to an embodiment of the present invention;

FIG. 5B schematically illustrates a side view of a representative wind turbine assembly comprised of a wind turbine coupled to a tower construction with guy wires according to an embodiment of the present invention;

FIG. 5C schematically illustrates a side view of a representative wind turbine assembly comprised of a wind turbine coupled to a hybrid tower construction with an external ladder on the lower section and an access door at the bottom of the upper section according to an embodiment of the present invention;

FIG. 6 illustrates symbolically the major components required for the construction method provided by one aspect of the present invention; and

FIGS. 7A-7E schematically illustrates the sequence of the provided construction method according to one aspect of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

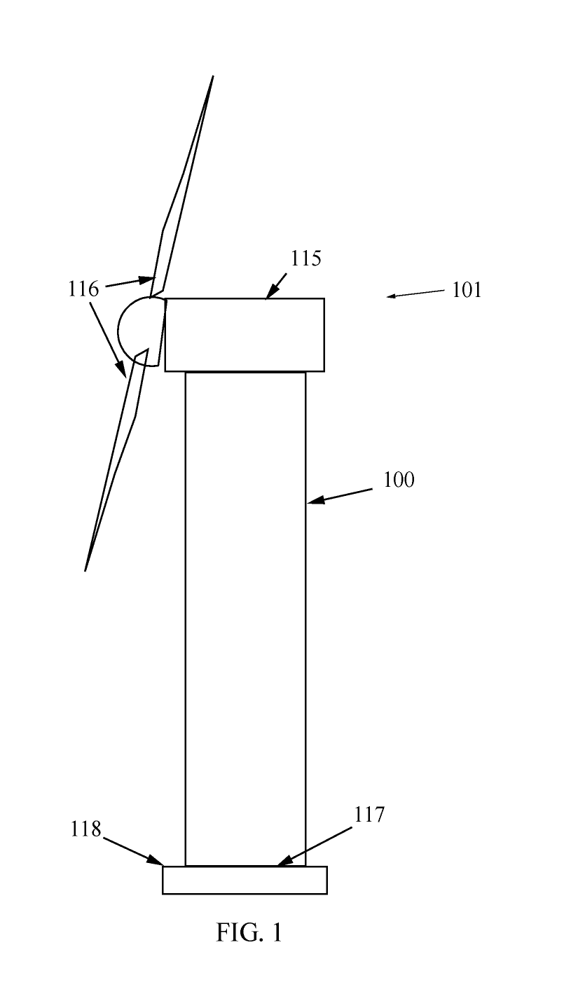

The wind turbine shown in FIG. 1 comprises a tower 100 bearing a machine nacelle 115 on its top end. A rotor including hub and blades 116 is attached to one side of the nacelle 115. The tower 100 is mounted via a connection 117 on a foundation 118. Typically, the tower foundation 118 is made of reinforced concrete. Generally, the tower 100 may be made of a single segment or a plurality of sections or segments that are assembled on site.

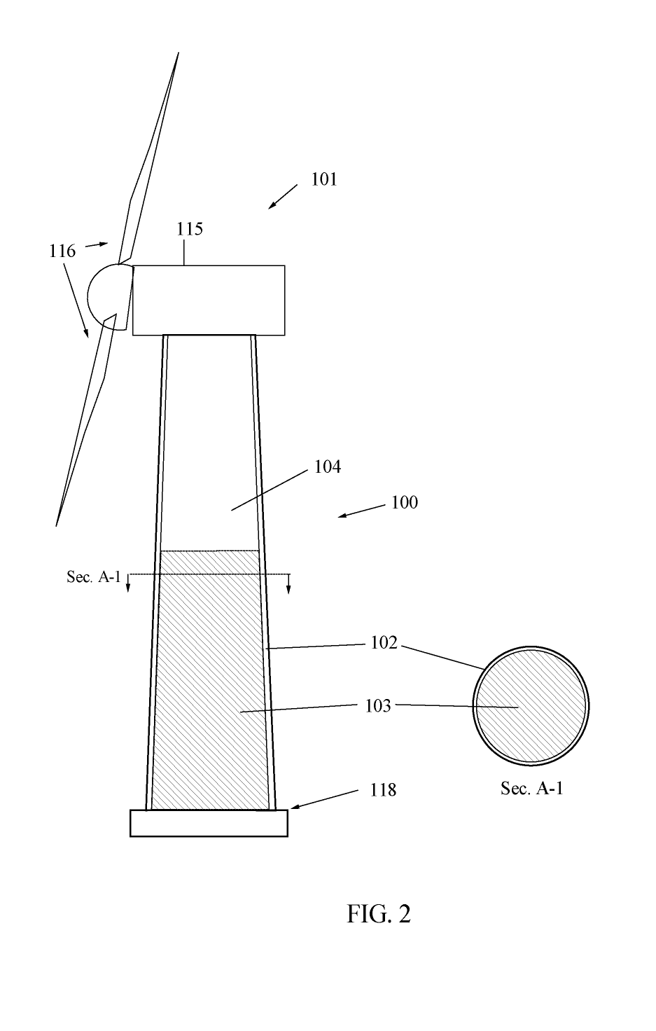

FIG. 2 illustrates a longitudinal section view of a wind turbine assembly comprised of a wind turbine 101 mounted on an inventive tower construction 100 according to one embodiment of the present invention, wherein the tower 100 comprises a support device with a tubular shell 102 that forms an elongated structural member 102. The support device further comprises a void 104 and a granular core 103 that is filling the void 104 for a substantial height of the tower 100. The granular fill 103 engages with the structural shell 102 and is preferably in intimate contact with the surrounding structural shell 102 such that the granular fill 103 exerts a pressure and provides a stiffness to the structural shell 102, particularly against local displacements.

Filling the void 104 with granular material 103 provides advantageous damping for the tower 100 vibrations. The principle behind particle damping is the removal of vibratory energy through losses that occur during impact or friction of granular particles which move freely with the boundaries of a void 104 attached to a primary system. Further, a significant degree of noise reduction can be achieved by filling structural members with granular materials. The tower 100 is responsible for a significant amount of the noise generated by a wind turbine assembly, so it is advantageous to add granular fill which can effectively and passively damp such vibrations.

In one embodiment of the present invention, the height of the granular fill 103 is selected as a means to tune the natural frequency of the structure to avoid resonance with the blade passing frequencies of the wind turbine 101.

Internal pressure and internal stiffness exerted on the structural shell 102 by engagement with the granular core 104 improves the buckling stability of the structural shell 102.

This leads to advantageous strength gains and a more favorable ductile failure behavior which can substantially reduce risks that are otherwise associated with buckling instabilities of traditional tubular tower sections. Further, the added buckling capacity provides advantages for fabrication and transportation of large tower base sections by allowing shell thickness reductions, especially in combination with higher yield strength steels, without substantial strength reductions that would be required for unstiffened sections.

In the embodiment shown in FIG. 2, the cross sectional area of the void 104 decreases from a first end of said void towards an opposite, second end of said void, wherein—when said elongated structural member 102 is in a substantially upright orientation during use—said first end forms the lower end of said void and said second end forms the upper end of said void 104. The void 104 has a non-constant cross sectional area, i.e. tapered diameter, which is largest at the base.

In one embodiment of the present invention, the structural shell 102 is made of high strength steel with a yield strength of 460 MPa or higher.

In another embodiment of the present invention, the majority of the granular core 103 comprises sand and/or recycled granular waste.

In another embodiment of the present invention, the structural shell 102, is made of an assembly of two or more circumferential segments which are longitudinally bolted together onsite to form the circular cross section.

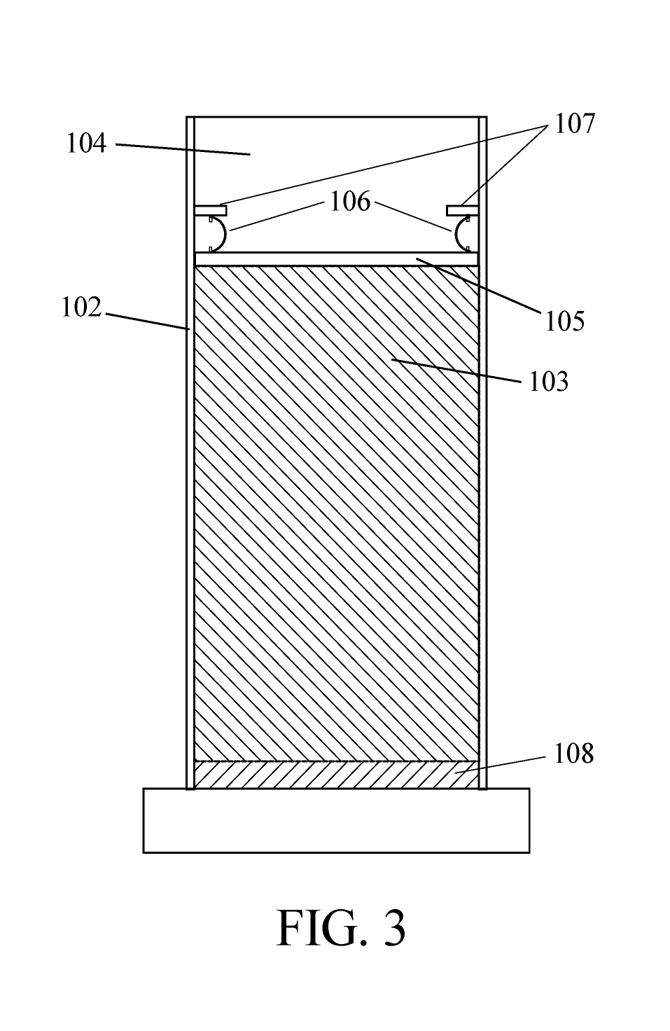

FIG. 3 schematically shows a longitudinal section view of an inventive tower construction with advantageous features provided by some embodiments of the present invention.

The tower construction is comprised of a cylindrical structural shell 102 wherein the void 104 is filled with a primary granular fill material 103 such that the granular material 103 engages with the structural shell 102 over the filled height and the granular fill 103 exerts a pressure and provides stiffness to the shell 102.

In one embodiment, the top surface of the granular fill 103 is bound by a cover, hereinafter referred to as cap 105, which engages with, e.g. rests on, the granular fill 103. The cap 105 is able to maintain engagement with the granular fill 103, for example in the event of settlement of the granular fill 103, by being unrestrained from small displacements in the longitudinal direction of the tower construction 100.

In another embodiment, the self-weight of the cap 105 and any equipment mounted on the cap 105 exerts a substantially constant confining pressure on the granular fill 103 over the design life.

FIG. 3 schematically shows a system for applying a confinement pressure to a granular fill core 103. The system comprises a cap 105 resting on the granular core 103 and a downward force is applied to the cap 105 by means of a plurality of buckled bars 106 which exert an equal and opposite upward force on the surrounding structural shell 102. Buckled bars are known to exhibit a nearly constant force for large displacements and they are easy to install and maintain. Further, the constant pressure on the granular core is preferable to simplify the design process. In one embodiment of the present invention, the buckled bars 106 exert the upward force on a flange 107 that is affixed to the surrounding shell 102. In another embodiment, the buckled bars 106 are evenly distributed around the circumference of the cap 105. In another embodiment, the buckled bars 106 are installed by popping them into place with no mechanical fastener. In another embodiment, the buckled bars 106 are mechanically fastened either rigidly or hinged to the flange 107 or shell 102. In another embodiment, one buckled bar 106 may be made of multiple less thick bars for the same target force but easier installation.

FIG. 3 also schematically shows a tower construction 100 provided by the present invention wherein the granular fill 103 is bound on the lower end by a different granular fill 108 with an average grain size that is at least 10% greater than the average grain size of the primary granular fill 103. The larger granular fill 108 may be at the base of the tower construction 100. The larger granular fill 108 is primarily advantageous for filtering moisture that may accumulate in the granular core. In one embodiment, the larger granular fill 108 is gravelly sand. In another embodiment, the larger granular material 108 is recycled granular waste.

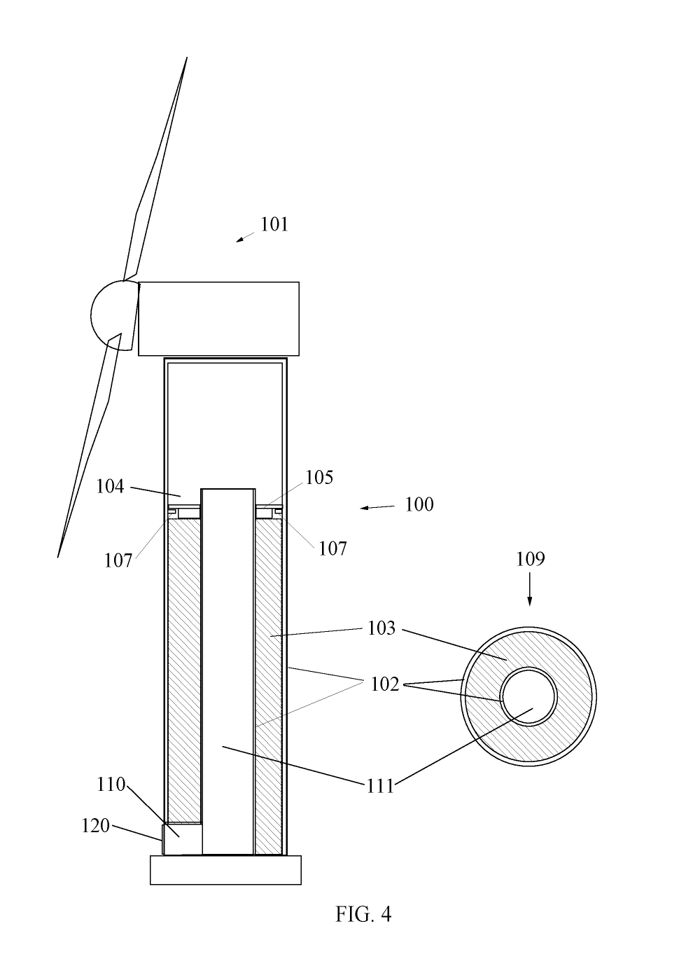

FIG. 4 schematically shows a longitudinal section view of an inventive wind turbine assembly and a section view of a granular filled sandwich type section 109. The wind turbine assembly is comprised of a wind turbine 101 and a tower 100 with features provided by certain embodiments of the present invention. The lower portion of the tower 100 comprises two concentric shells 102 forming a granular filled sandwich type section 109 wherein the void 104 is an annular void 104 between the shells, wherein said annular void 104 is filled with a granular core 103. When compared to traditional sandwich sections such as steel-grout-steel or steel-elastomer-steel, some aspects of the present invention provides advantages by having easy on site fill-up, requiring no cure time and allowing a very large core thickness without negative cost implications.

Reduction of shell thickness addresses critical fabrication and transportation challenges for large tower structures such as those challenging the deployment of taller and larger wind energy converters onshore.

One embodiment of the present invention comprises a granular filled sandwich section wherein the outermost shell 102 is a high strength steel with yield stress of 460 MPa or higher and the inner shell 102 is low- or medium strength steel such as S235 or S355. This combination of high strength outer shell 102 and low strength inner shell 102 lead to advantages in cost and fabrication.

In another embodiment, the top surface of the granular core 103 is in engagement with a cap 105 member. According to an embodiment, the cap 105 member is mechanically bolted to a radial flange 107 extending from the outer shell 102 into the annular void 104. In another embodiment, a confining pressure is applied to the granular fill 103 by the cap 105 by tightening bolts connecting the cap 105 member to the radial flange 107. The loading of the cap 105 member exerts an opposite upward force on the flange 107 which introduces advantageous tensile stresses in the structural shell 102.

The hollow inner shell 102 in FIG. 4 provides advantages for weight optimization, tuning dynamics, equipment storage space, cable placement, or added structural stiffness where diameters may be constrained.

The cap 105, which is mechanically joined to the shell 102, allows high levels of advantageous confining pressure to be applied to the granular fill 103 while simultaneously inducing advantageous tensile stresses in the structural shell 102 which tends to further stabilize the shell 102 against local buckling.

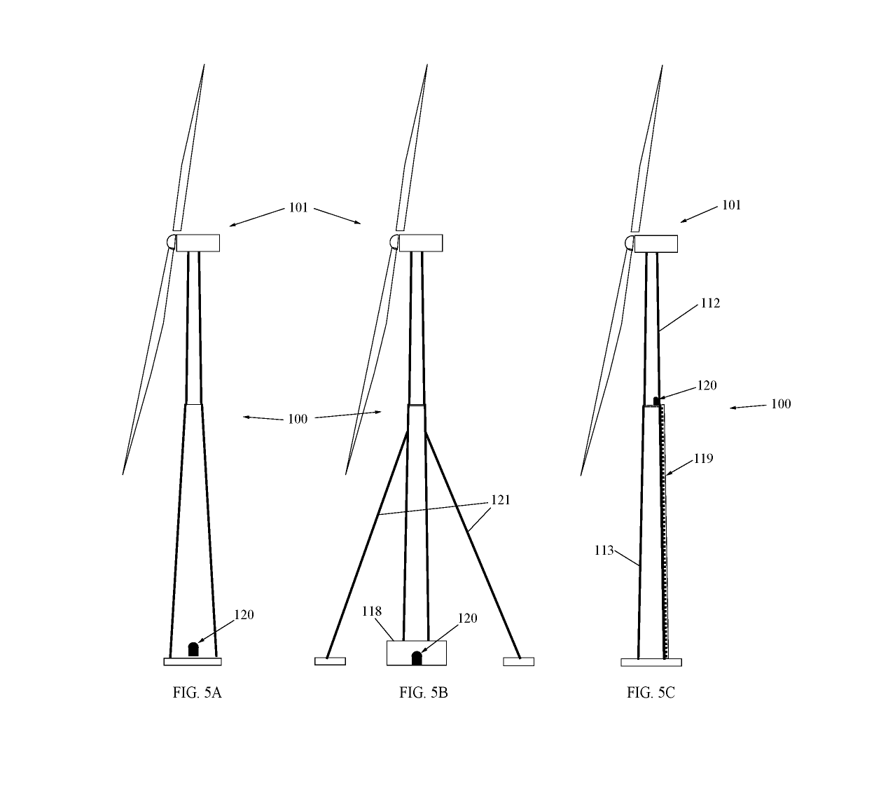

FIG. 5A to FIG. 5C schematically illustrate configurations for wind turbine assemblies especially suitable for the present invention.

FIG. 5A is a side view of a wind turbine comprised of a tapered or conical tower 100 according to one embodiment of the present invention with an access door 120 leading to an inner hollow core. A tapered shell 102 is advantageous for increasing stiffness and material utilization.

FIG. 5B is a side view of a wind turbine comprised of a tower 100 with guy wires 121. The guyed tower is mounted on a foundation 118 with an integral access portal and door 120 for access to stored equipment or for internal access to the wind turbine 101. In particular, the damping of the present tower invention is advantageous for use in slender towers that are supported with guy wires 121.

FIG. 5C schematically illustrates a wind turbine assembly comprised of a wind turbine 101 coupled to a tower 100. The tower 100 is a hybrid tower with two sections: and upper section 112 and a lower tubular section 113 wherein the lower tubular section 113 is filled with granular fill 103. In one embodiment, the upper section 112 is a hollow tubular traditional tower.

According to an embodiment of the present invention, the transition between the lower and upper section occurs between ¼ and ¾ the total height of the tower construction 100. In another embodiment, the upper tower section 112 is a lattice structure. In another embodiment, the upper tower section 112 is a lattice structure with a façade to mimic a cylindrical appearance. According to an embodiment of the present invention, the lower section 113 may be comprised of an external ladder and an external cable conduit, with an access door 120 at the base of the upper section 112.

The lower section 113 of some embodiments may be referred to as a pedestal. In one embodiment, a traditional 80 meter tubular tower is placed on top of a 40 meter pedestal. In another embodiment a traditional 80 meter tubular tower is mounted on top of a 60 meter pedestal. The use of a lower pedestal section 113, is advantageous for developers making hub height decisions for development of a wind farm. FIG. 5A, FIG. 5B, and FIG. 5C are provided to illustrate the flexibility of the present invention. One skilled in the art will recognize that the present invention is not limited to the side view geometry, means of access, or number of sections/components in the tower assembly.

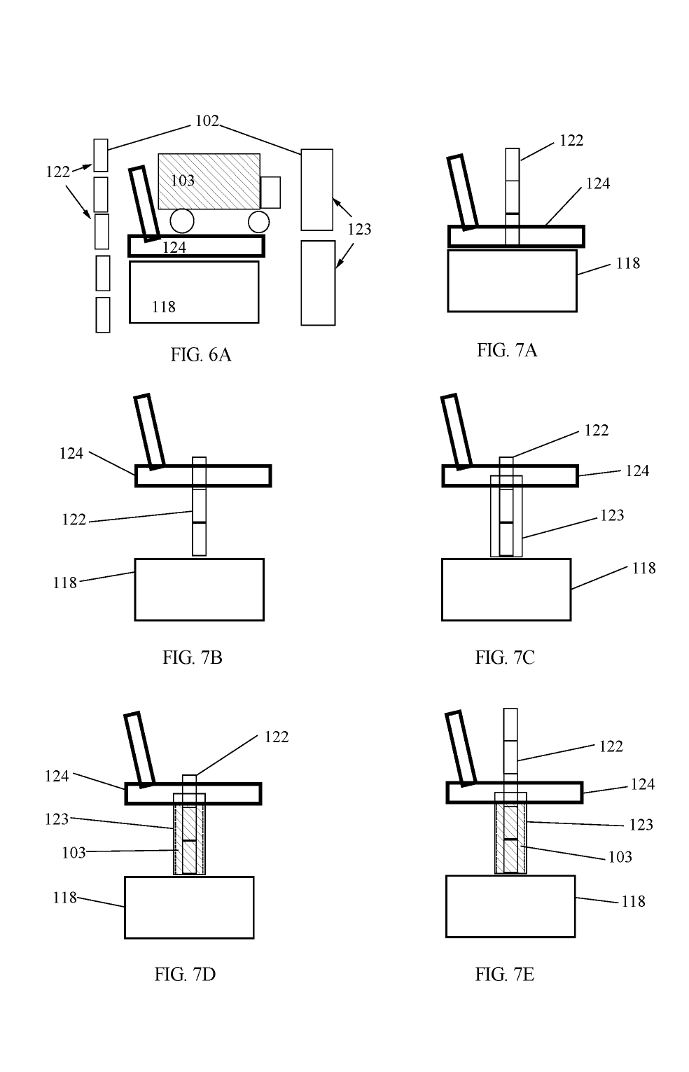

FIG. 6 illustrates symbolically the major components required for the construction method provided by one aspect of the present invention. The major components include inner shell segments 122, outer shell segments 123, granular fill 103, tower foundation 118, and a lifting system 124 similar in utility to those employed for jump-fill concrete construction.

FIGS. 7A-7E schematically illustrates the sequence of the provided construction method according to one aspect of the present invention. First the lifting system 124 is positioned on or around the wind turbine structure's foundation 118, then a length of the inner shell 122 is erected by the lifting system 124 at the center of the lifting system 124 (FIG. 7A). The lifting system 124 then establishes connection with the inner shell 122 and raises itself to an elevated position (FIG. 7B). Subsequently a substantial height of the outer shell 123 is installed below the lifting system 124 wherein the outer shell 123 is assembled from two or more circumferential segments longitudinally joined in-situ (FIG. 7C). Then the annular void 104 separating the two shells may be filled with the granular core 103 up to near the current level of the lifting system 124 (FIG. 7D). The lifting system 124 then lifts the next length of the inner shell 122 (FIG. 7E) and the steps are repeated as the tower construction 100 is built taller. The construction method provided is similar is utility to the jump-form construction method used in concrete construction by eliminating traditional crane height limitations, and further it does not require curing time like jump- or slip-form concrete construction does.

The present invention also addresses the problem of recycling existing tower installations by not only utilizing, but naturally benefiting from the existing tower construction.

The pre-existing tower construction could be adapted to serve as the inner core of the present invention, and together the structural system could be adapted to meet the demands of any modern wind turbine. The fatigue damage incurred on the old tower may have little significance as it will no longer be a primary structural member, but rather a mere secondary structural member serving functional purposes.

In summary, the present invention is expected to have one or all of the following advantages:
reduced shell thicknesses compared to hollow tubular sections;
increased ultimate strength in terms of buckling capacity compared with traditional towers;
simple means for tuning dynamics of tower construction system;
superior fabrication and transportation logistics compared with conventional sandwich sections;
increased safety and robustness compared to traditional towers; and
potential means for recycling existing tower installations.

Although they show selected embodiments of the invention, the above described embodiments are intended only to illustrate the invention and not to limit in any way the scope of the invention. Although the FIGs. show a representative wind turbine assembly to which the embodiments of the present invention can be advantageously applied, it should be understood that the present invention is not limited or restricted to wind turbines but can also be applied to tower structures used in other technical fields. In particular the various embodiments of the invention may also be applied to large slender tower constructions such as telecommunication towers, offshore wind turbines, bridge pylons, masts, offshore piles, guyed towers and water towers.

It should be understood that where features mentioned in the appended claims are followed by reference signs, such signs are included solely for the purpose of enhancing the intelligibility of the claims and are in no way limiting on the scope of the claims.

Furthermore, it is particularly noted that the skilled person can combine technical measures of the different embodiments. The scope of the invention is therefore defined solely by the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A support device, more particularly a structural part of a tower construction for mounting a wind turbine, comprising:
at least one elongated structural member comprising one or more voids extending over a substantial height of said elongated structural member; and
a granular core filling material filling at least one of the one or more voids extending over a substantial height of said elongated structural member, wherein the granular core filling material is in engagement with the structural member such that it exerts a pressure and provides stiffness against deformation on the surrounding structural member.

28. The support device of claim 27, wherein the hollow elongate member comprises a substantially axis-symmetric structural member.

29. The support device of claim 27, wherein the granular filling material comprises a substantially rigid solid-state material.

30. The support device of claim 27, wherein the cross sectional area of at least one of the voids decreases from a first end of said void towards an opposite, second end of said void, wherein—when said elongated structural member is in a substantially upright orientation during use—said first end forms the lower end of said void and said second end forms the upper end of said void.

31. The support device of claim 27, wherein the granular filling material is arranged in said void under pre-pressure.

32. The support device of claim 29, wherein the granular filling material is bound on at least one end by a cover that completely fits in the one or more voids and wherein said cover is in engagement with the granular filling material.

33. The support device of claim 32, wherein the cover rests on the granular filling material and is free to move in the longitudinal direction of the elongated structural member such that the self-weight of the cover and the weight of any equipment potentially mounted on the cover acts to exert a confining pressure on the granular filling material.

34. The support device of claim 33, further comprising pre-stressing means that are configured for pressing the cover towards the granular filling material.

35. The support device of claim 34, wherein the pre-stressing means comprise a plurality of buckled bars which exert substantially equal and opposite forces on the cover and the surrounding structural member.

36. The support device of claim 32, wherein the at least one structural member comprises a flange extending radially in to the void, and wherein the cover is arranged on the flange.

37. The support device of claim 27, wherein the granular filling material is bound on one end by a layer of different granular filling material with at least 10% larger average grain size as the primary granular fill.

38. The support device of claim 27, wherein the outermost structural member has a diameter to thickness D/t ratio greater than 30.

39. The support device of claim 27, wherein at least one structural member is made of steel with yield stress grade of 460 MPa or higher.

40. The support device of claim 27, wherein the granular fill is sand.

41. The support device of claim 27, wherein the voids have an annular shape.

42. The support device of claim 27, comprising at least an inner and an outer structural member, which together form a sandwich type section.

43. The support device of claim 42, comprising a portal between the inner and outer structural member allowing personnel access to an inner core of the support device.

44. The support device of claim 27, wherein the support device is part of a tower construction, more particular a tower construction for mounting a wind turbine.

45. A tower construction, comprising at least one support device according to claim 27.

46. A wind turbine assembly comprising a wind turbine and a hybrid tower, wherein said hybrid tower comprises an upper tower section and a lower tower section, wherein said upper section comprises an elongate structural member, and wherein the lower section comprises a support device according to claim 27.

47. The wind turbine assembly according to claim 46, wherein the lower section accounts for ¼ to ¾ of the total height of the tower, and wherein the upper section accounts for the remaining ¼ to ¾ of the total height.

48. A method for improving a support device comprising at least one elongated structural member comprising one or more voids extending over a substantial height of said elongate structural member, comprising the step of filling at least one of the one or more voids over a substantial height of said elongated structural member with a granular core filling material, wherein the granular filling material is in engagement with the structural member such that it exerts a pressure and provides stiffness against deformation on the surrounding structural member.

49. The method according to claim 48, wherein a support device according to claim 27 is used.

50. A method for constructing a support device according to claim 27, wherein a lifting system similar to jump-fill concrete systems equipped with a lifting crane is employed to construct, climb and fill the structural members by the following method steps:
positioning the lifting system on or around a foundation;
erecting an elongated inner structural member by the lifting system at the center of the lifting system;
establishing a connection of the lifting system with the inner structural member;
raising the lifting system along said inner structural member to an elevated position;
arranging a segment of an outer structural member below the lifting system, wherein the outer structural member is assembled from two or more circumferential segments; and
filling an annular void separating the inner and outer structural members with granular core filling material filling the annular void over a substantial height of said elongated structural members, wherein the granular filling material is in engagement with the structural members such that it exerts a pressure and provides stiffness against deformation on the surrounding structural members.

51. The method according to claim 50, wherein the steps are repeated to build a tower construction taller using multiple structural members.

52. The method according to claim 50, wherein a support device according to claim 27 is assembled.
